(19) United States
(12) Patent Application Publication
(10) Pub. No.: US 2011/0215212 A1
(43) Pub. Date: Sep. 8, 2011

(54) VERTICAL MOUNTING SYSTEM

(75) Inventor: Aydin Keyvanloo, Doncaster (AU)

(73) Assignees: Aydin Keyvanloo, Doncaster (AU); Andreas Klaus Gesswein, Rintein (DE); Liang Tung, Taipei City (TW)

(21) Appl. No.: 13/128,271

(22) PCT Filed: Nov. 12, 2009
(86) PCT No.: PCT/AU2009/001473

§ 371 Date: May 9, 2011

(30) Foreign Application Priority Data
Nov. 14, 2008 (AU) 2008905917

(51) Int. Cl. F16M 13/02

(52) U.S. Cl. 248/220.22

(57) ABSTRACT

A mounting system (10), for mounting a component (62), including a body section (14) for attaching to a vertical surface (12), the body section including a mounting channel (36) and a mounting strip (16) receivable within the mounting channel (36). The mounting strip (16) includes one or more mounting slots (44) and wherein the mounting slots (44) are accessible from outside the body section (14) when the mounting strip (16) is received within the mounting channel (36).

### FIELD OF THE INVENTION

The present invention relates to a vertical mounting system for mounting a variety of arms and shelving components. The present invention finds particular, though not exclusive, application in a retail display environment.

### BACKGROUND OF THE INVENTION

In retail stores, clothing and goods for sale are typically presented on display arms or shelving units that generally form part of a standalone display stand or are mounted on walls or other large display units.

Garments for example are typically hung from hangers, which are then suspended from the arms. The arms are either straight poles or are equipped with dividers to space out the hangers and garments to ensure all garments are visible. Other items, such as folded apparel, are generally presented on shelving.

In retail environments, it is often desirable to change the way in which items are presented for sale, particularly as stock changes. In some instances display arms are the preferred manner of presenting items whereas on other occasions display shelves are more desirable.

It is also desirable in retail environments to be able to readily mount display arms and shelves at various vertical positions on a wall depending on the items to be displayed.

It is therefore an object of the present invention to provide a mounting system that at least in part provides some of the advantageous features mentioned above.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

In accordance with the present invention there is provided a mounting system, for mounting a component, including:
a body section for attaching to a vertical surface, the body section including a mounting channel;
a mounting strip receivable within the mounting channel;
wherein the mounting strip includes one or more mounting slots and wherein the mounting slots are accessible from outside the body section when the mounting strip is received within the mounting channel.

Most preferably, the body section is formed as an extrusion such that the mounting channel is an elongate channel that is able to receive the mounting strip. Preferably the extrusion is of uniform cross-section and is made of aluminium or similar material.

Advantageously, the mounting strip is a longitudinal component configured to be received within the mounting channel. The mounting strip preferably includes a plurality of mounting slots, spaced longitudinally along the length of the mounting strip.

The mounting slots are preferably sized and shaped to detachably receive engagement means of associated display components, such as various display arms, shelf brackets, and shelves, as will be described in further detail below.

Preferably, the mounting system of the invention is configured to be installed on or within a wall or similar vertical surface, thereby providing a vertically extending mounting channel. The body section of the mounting system is preferably configured to enable the mounting system to be fixedly attached to the rear of a wall or mounted within a wall cavity.

The mounting system of the invention preferably further includes securing means for securing the mounting strip within the mounting channel. The securing means may take the form of end stops that can permanently secure the mounting strip within the mounting channel or alternately can permit removal of the mounting strip from the mounting channel when desired. End caps may also be provided to close the respective ends of the mounting channel and provide an aesthetic appearance.

The mounting system of the invention is most preferably provided in kit form to an end user. The end user then has responsibility for the assembly of the mounting system and can customise the components, such as length of the system, according to individual requirements.

### BRIEF DESCRIPTION OF THE FIGURES

The invention will now be described by way of example only, with reference to the accompanying figures, in which:

FIG. 1 is an exploded view of the components of a mounting system according to an embodiment of the invention;

FIG. 2 is a front perspective view of the mounting system of FIG. 1 fixed to the rear of a wall and supporting a display component;

FIG. 3(a) illustrates the assembly of the mounting system of FIG. 1; and FIG. 3(b) illustrates the assembled mounting system prior to fixing to a wall surface;

FIG. 4 is a cross-sectional end-view of the mounting system fixed to a wall;

FIG. 5 is a front view of the mounting system fixed to a wall;

FIGS. 6(a) to 6(g) illustrate various cross-sections of body sections according to alternative embodiments of the invention; and

FIGS. 7(a) to 7(c) illustrate various forms of end-stops according to alternative embodiments of the invention.

### DETAILED DESCRIPTION OF THE EMBODIMENTS

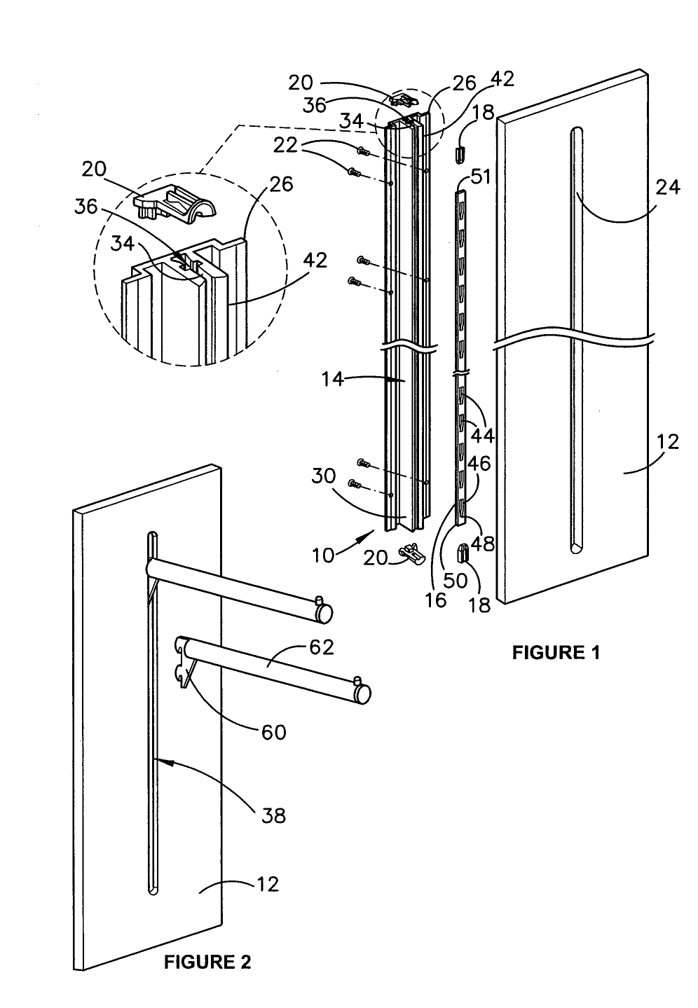

Referring to FIG. 1 there is shown a mounting system 10 according to an embodiment of the invention and a wall surface 12. The primary components of the mounting system 10 are a body section 14, and mounting strip 16. Also provided are end stops 18, end caps 20, and screws or similar fixing means 22. Wall 12 is provided with a longitudinal aperture 24 for access to the mounting system mounted behind the wall, as will be described below.

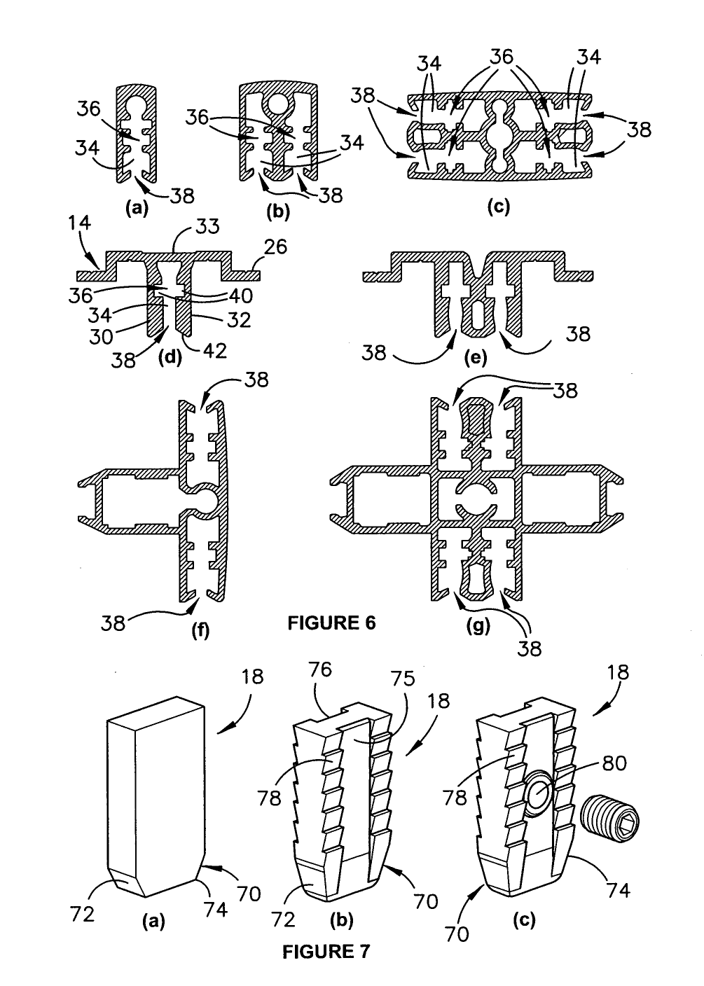

The body section 14 is preferably formed as an aluminium extrusion which allows it to be manufactured at various lengths depending on consumer needs. Various profiles of the extrusions are illustrated in FIGS. 6(a) to 6(g). For the purpose of the discussion below, the profile of the extruded body section 14 shown in FIG. 1 is that more clearly illustrated in FIG. 6(d).

The body section 14 is configured to be fixedly attached to the rear of a wall surface 12 or within a wall cavity and for that purpose is preferably provided with a pair of laterally extending flanges 26 extending the length of the extrusion. In use, the flanges 26 abut the rear surface of the wall and preferably include preformed holes to allow the passage of screws 22 to fix the body section to the wall.

The body section 14 includes a rear wall 23 that is spaced rearwardly from the flanges 26 such that it is spaced from the wall surface 12 when installed. This configuration assists in bracing the body section 14 to the wall surface 12 and also allows passage of additional supporting members (not shown) if necessary.

A pair of forwardly extending arms 30, 32 are provided centrally of the body section 14. Arms 30, 32 form a channel 34 between them, and are shaped and configured to define a mounting channel 36 and access opening 38.

As best illustrated in FIG. 6(d), the arms 30, 32 extend perpendicularly forwardly of the rear wall 33 of the body section 14. Partway along their length, approximately in line with a wall surface 12 (when installed) the arms 30, 32 are each formed with a rectangular-shaped recess 40. The pair of recesses 40 are opposed to each other and between them define the mounting channel 36. The shape of the recesses 40, including their width and depth as well as their distance apart is configured to complement the dimensions of a mounting strip 16 to be received within the mounting channel 36. The dimensions may be such that the mounting strip 16 can be freely slid into the mounting channel 36 or dimensioned so that it requires force to move it into position.

Forwardly of the mounting channel 36, channel 34 extends to the access opening 38 at the distal ends 42 of the arms 30, 32. The ends 42 of the arms 30, 32 are preferably chamfered or tapered inwardly towards channel 34 at opening 38 to provide an aesthetic appearance and to direct a user towards the mounting strip 16 located within the mounting channel 36.

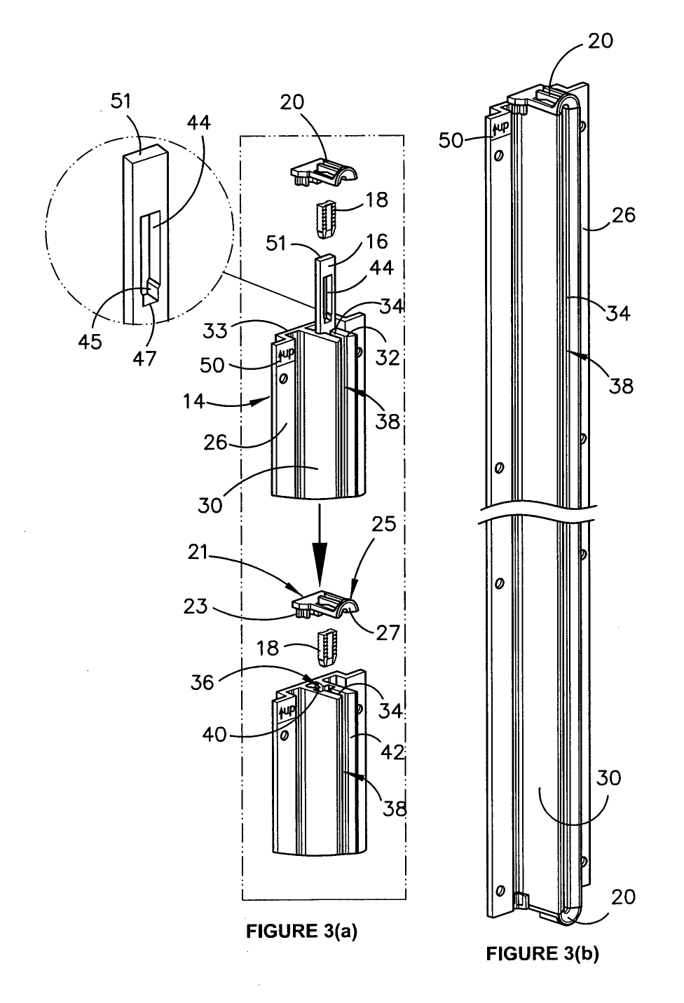

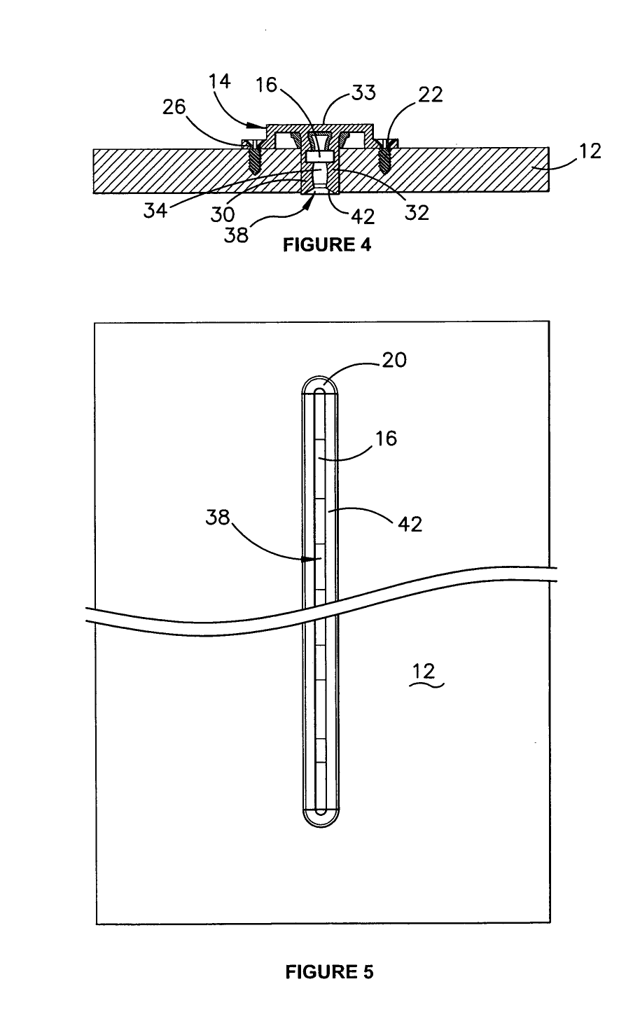

Arms 30, 32 are configured to pass through and be received within aperture 24 formed in wall surface 12. Preferably, the length of the arms 30, 32 is such that, when installed, the distal ends 42 of the arms sit flush with the front of the wall surface 12, as best illustrated in FIG. 3(b) and FIG. 4.

Mounting strip 16 is preferably formed as a steel strip enabling it to be manufactured or cut at any desired length. Referring to FIG. 1 and FIG. 3(a), mounting strip 16 is elongate and is generally rectangular in cross-section. It is shaped to be received within the mounting channel 36 as described above.

Mounting strip 16 is provided with a plurality of mounting slots 44 spaced regularly along its length. Mounting slots 44 are preferably formed in the mounting strip 16 by punching, cutting or similar techniques. As best illustrated in FIG. 3(a), each mounting slot 44 is generally rectangular although other shapes could be utilised. The lower end 45 of each mounting slot 44 is preferably formed with a pair of inwardly directed steps that reduce the internal dimensions of the slot 44 at the lower end 45. This reduction in internal dimension enables the engagement means 60 of a display component 62 to be inserted into the slot 44 towards the middle or upper portion of the slot 44, and then lowered to the base 47 of the slot and securely received within the smaller lower end 45 of the slot 44.

In particularly preferred embodiments, the lowermost mounting slot 46 (see FIG. 1) is always formed with its lowermost edge 48 the same distance from the bottom end 50 of the mounting strip 16. For example, this distance may be 5 mm. The remaining mounting slots 44 are then spaced in regular intervals from the lowermost mounting slot 46. This consistent spacing of mounting slots 44 in all mounting strips 16 enables a person installing more than one mounting system 10 on a wall to accurately align mounting slots 44 of adjacent mounting systems 10. This is not only useful in terms of the overall visual impression of a number of mounting systems 10 mounted alongside one another on a wall, but is particularly useful if the mounting slots 44 are intended to be used to mount shelving supports and it is essential that the respective heights of the mounting slots 44 are accurately aligned. To assist in proper installation of the mounting system 10, the body section 14 preferably includes an indicator 50 of the upward end.

End stops 18 enable the mounting strip 16 to be secured within the mounting channel 36, either permanently or temporarily. Alternate forms of end stops 18 are illustrated in FIGS. 7(a) to 7(c). Each of the alternate end stops are of generally rectangular box-like configuration. The lower ends 70 of the end stops 18 are tapered inwardly at each side 72, 74 to assist in inserting the end stops 18 into the lower and upper ends 50, 51 of the mounting channel 36. The end stops are preferably sized to be a tight fit within the mounting channel 36 to prevent their accidental removal or tampering.

As illustrated in FIG. 7(b) and (c), the front and rear faces 75, 76 of the end stops 18 may be provided with a series of steps or serrations 78 which further resist removal of the end stops 18 from the mounting channel 36. The end stop 18 may be provided with a preformed hole 80 into which a securing device such as a screw-threaded lug may be inserted.

Finally, end caps 20 are provided to close the respective ends 50, 51 of the mounting channel 36 and to complete the access opening 38. End caps 20 include a rear section 21 that is generally planar and includes locating lugs 23 extending from one face thereof, as best illustrated in FIG. 3(a). The locating lugs 23 are configured to be received within the respective ends of the body section 14 (best seen in FIG. 3(b) and FIG. 4) to secure the end caps 20 in position. The forward section 25 of the end caps 20 is preferably rounded in shape for aesthetic purposes but could be square or rectangular if desired. The end caps 20 include at their front end a chamfered or tapered surface 27 consistent with the ends 42 of arms 30, 32.

The mounting system 10 is preferably provided in kit form to an end user which enables the end user to customise the vertical length of the mounting system 10. To install the mounting system 10, the end user first determines the desired length of the mounting channel 36 and cuts or alters the length of both the body section 14 and mounting strip 16 accordingly. An aperture 24 of the required dimensions is formed in the desired wall surface 12.

As illustrated in FIG. 3(a) the mounting strip 16 is then located within the mounting channel 36, ensuring that both components have their respective upper ends directed upwardly. End stops 18 are then inserted into the respective ends of the mounting channel 36 and end caps 20 are inserted into the respective ends of the body section 14. The assembled mounting system as illustrated in FIG. 3(b) in then fixed to the rear of a wall surface using screws 22. Arms 30, 32, extend through aperture 24 and present the access opening 38 in the wall surface.

Display components 62 can then be mounted to the wall via the mounting slots 44 of the mounting strip 16 which is accessible through opening 38. The display components include engagement means 60 that complement the mounting slots 44 and are snugly received therein. The display components 62 may be display arms used for supporting garment hangers, a mounting bracket for supporting a glass shelf, an aluminium shelf, or similar components.

It will be appreciated that a number of mounting systems 10 may be installed in a wall 12 alongside each other to provide a number of vertically extending mounting channels 36. It will also be appreciated that extruded body sections having alternate profiles may be utilised. Some examples of these are illustrated in FIGS. 6(a) to 6(g). FIG. 6(e) for example illustrates a body section similar to that of FIG. 6(d) but having dual mounting channels side by side. FIGS. 6(a) and 6(b) depict profiles for a system fixed externally by spaced mounting brackets. The FIG. 6(c) profile, facing in opposed directions, is for ‘mid-floor’ furniture and hence is attached on a base. FIGS. 6(f) and 6(g) are also for specialised ‘mid-floor’ fittings.

It will be appreciated that the mounting system of the invention allows for the easy attachment and detachment of a variety of display arms, shelving, brackets, and similar display components. It enables the display presented to a consumer in a retail environment to be kept fresh and ever changing due to the flexibility in the configuration of the retail display.

It will be understood that the invention disclosed and defined in this specification extends to all alternative combinations of two or more of the individual features mentioned or evident from the text or drawings. All of these different combinations constitute various alternative aspects of the invention.

1. A mounting system, for mounting a component, including:
a body section for attaching to a vertical surface, the body section including a mounting channel;
a mounting strip receivable within the mounting channel;
wherein the mounting strip includes one or more mounting slots and wherein the mounting slots are accessible from outside the body section when the mounting strip is received within the mounting channel.

2. A mounting system according to claim 1, wherein the body section is formed as an extrusion such that the mounting channel is an elongate channel that is able to receive the mounting strip.

3. A mounting system according to claim 2, wherein the extrusion is of uniform cross-section.

4. A mounting system according to claim 1, wherein the mounting strip includes a plurality of mounting slots, spaced longitudinally along the length of the mounting strip.

5. A mounting system according to claim 4, wherein the mounting slots are sized and shaped to detachably receive engagement means of associated display components.

6. A mounting system according to claim 1, configured to be installed on or within a wall or similar vertical surface, thereby providing a vertically extending mounting channel.

7. A mounting system according to claim 6, wherein the body section is configured to enable the mounting system to be fixedly attached to the rear of a wall.

8. A mounting system according to claim 1, wherein the body section is configured to enable the mounting system to be fixedly mounted within a wall cavity.

9. A mounting system according to claim 1, further including securing means for securing the mounting strip within the mounting channel.

10. A mounting system according to claim 9, wherein the securing means takes the form of end stops that can permanently secure the mounting strip within the mounting channel or alternatively can permit removal of the mounting strip from the mounting channel when desired.

11. A mounting system according to claim 10, wherein end stops are also provided to close the respective ends of the mounting channel and provide an aesthetic appearance.

12. A mounting system according to claim 2, wherein the mounting strip includes a plurality of mounting slots, spaced longitudinally along the length of the mounting strip.

13. A mounting system according to claim 12, wherein the mounting slots are sized and shaped to detachably receive engagement means of associated display components.

14. A mounting system according to claim 6, wherein the mounting strip includes a plurality of mounting slots, spaced longitudinally along the length of the mounting strip.

15. A mounting system according to claim 14, wherein the body section is formed as an extrusion such that the mounting channel is an elongate channel that is able to receive the mounting strip.

16. A mounting system according to claim 8, wherein the mounting strip includes a plurality of mounting slots, spaced longitudinally along the length of the mounting strip.

17. A mounting system according to claim 16, wherein the body section is formed as an extrusion such that the mounting channel is an elongate channel that is able to receive the mounting strip.

18. A mounting system according to claim 4, further including securing means for securing the mounting strip within the mounting channel.

19. A mounting system according to claim 18, wherein the securing means takes the form of end stops that can permanently secure the mounting strip within the mounting channel or alternatively can permit removal of the mounting strip from the mounting channel when desired.

20. A mounting system according to claim 19, wherein end stops are also provided to close the respective ends of the mounting channel and provide an aesthetic appearance.
